(19) United States
(12) Patent Application Publication
(10) Pub. No.: US 2013/0088467 A1
(43) Pub. Date: Apr. 11, 2013

(54) IMAGE DISPLAY SYSTEM

(71) Applicants: Nobuo JIKUYA, Kumamoto (JP); Takehiko IDE, Saga (JP); Hitoshi FUJIMOTO, Fukuoka (JP); Kazumi OHTSUBO, Fukuoka (JP); Ryosuke ARAKI, Tokyo (JP)

(72) Inventors: Nobuo JIKUYA, Kumamoto (JP); Takehiko IDE, Saga (JP); Hitoshi FUJIMOTO, Fukuoka (JP); Kazumi OHTSUBO, Fukuoka (JP); Ryosuke ARAKI, Tokyo (JP)

(73) Assignee: PANASONIC CORPORATION, Osaka (JP)

(21) Appl. No.: 13/609,975

(22) Filed: Sep. 11, 2012

(30) Foreign Application Priority Data
Oct. 7, 2011 (JP) JP2011-222487

(51) Int. Cl. G09G 5/00

(52) U.S. Cl. 345/204

(57) ABSTRACT

The housing of the image display system is given with a rectangular box shape, and contains an optical system for projecting an image on a screen and a control circuit board for controlling the optical system and electrically connected to the first unit one above the other. Therefore, the image display system is compact enough and simply shaped enough for the user to carry it without any inconvenience.

### TECHNICAL FIELD

1. Field of the Invention

The present invention relates to an image display system using a semiconductor laser for a light source thereof, and in particular to a compact image display system suited to be connected to portable electronic devices.

2. Description of the Related Art

In recent years, there is a growing interest in the use of a semiconductor laser as the light source of image display systems. The semiconductor laser has various advantages over the mercury lamp which is commonly used as the light source for more conventional image display systems, such as a better color reproduction, the capability to turn on and off instantaneously, a longer service life, a higher efficiency (or a lower power consumption) and the amenability to compact design.

A particularly attractive advantage of the image display system using a semiconductor laser is that it can be constructed as a highly compact unit. For instance, it has been proposed to incorporate an image display system in a portable laptop personal computer so that the data processed by the personal computer may be directly projected on a screen. See JP08-328487A, for instance. In such a case, the personal computer is not required to be connected to the image display system with a cable, and this is a highly convenient feature for the user.

However, according to the technology disclosed in JP08-328487A, the image display system consisting of a projector permanently protrudes from the outer profile of the personal computer, and this detracts from the portability of the personal computer. On the other hand, if the image display system is designed to be internally installed in the personal computer, the shape of the image display system is inevitably highly complex, and this makes the image display system to be highly inconvenient to be removed from the personal computer and transported by itself. For instance, the image display system may be too bulky and oddly shaped to be stored in a pocket of a user.

### BRIEF SUMMARY OF THE INVENTION

In view of such problems of the prior art, a primary object of the present invention is to provide an image display system which is compact enough for the user to carry it without any inconvenience.

A second object of the present invention is to provide an image display system which is simply shaped enough for the user to carry it without any inconvenience.

To achieve such an object, the present invention provides an image display system, comprising: a first unit containing an optical system for projecting an image on a screen; a second unit containing a control circuit board for controlling the optical system and electrically connected to the first unit; and a housing containing the first unit and the second unit one above the other therein, and having a rectangular box shape.

According to the present invention, because the first unit and the second unit forming the image display system are placed one above the other, the area of the wall of the housing defining the outer profile of the image display system can be minimized. Because the housing is provided with a rectangular box shape, the image display system can be easily carried by the user. Thus, the image display system of the present invention is compact in size and simple in shape so as to be easily handled and transported by the user.

Preferably, the first unit is located above the second unit. Thereby, the projecting light is emitted from a relatively upper part of the image display system so that the image may be projected on a wall with a minimum upward slanting angle of the projecting light, and the trapezoidal and other image correction can be simplified.

According to a particularly preferred embodiment of the present invention, the housing comprises a projection window for emitting light generated by the first unit to outside, and a face of the housing facing away from the projection window is shaped planar such that the projection window faces upward when the planar face is placed on a horizontal surface. Thereby, the image can be projected onto a ceiling without requiring any special arrangement.

### BRIEF DESCRIPTION OF THE DRAWINGS

Now the present invention is described in the following with reference to the appended drawings, in which:

FIG. 1 is a perspective view of a laptop information processing apparatus connected to an image display system embodying the present invention;

FIGS. 2a and 2b are perspective views of the image display system as seen from two opposite directions;

FIG. 3 is an exploded perspective view of the image display system;

FIG. 4 is a diagram showing the structure of an optical engine unit of the image display system;

FIG. 5 is a side view showing the image display system projecting an image onto a wall in an upwardly slanted direction;

FIG. 6 is a side view showing the image display system projecting an image onto a ceiling in a vertical direction; and

FIG. 7 is a side view showing the image display system projecting an image onto a wall in a horizontal direction.

### DETAILED DESCRIPTION OF THE PREFERRED EMBODIMENT(S)

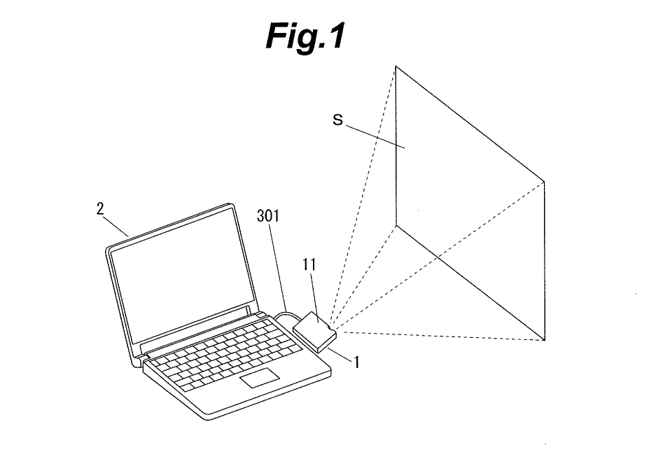

An embodiment of the present invention is described in the following with reference to the appended drawings. FIG. 1 is a perspective view of a laptop information processing apparatus 2 connected to an image display system 1 embodying the present invention.

A connector is provided on a lateral side of the image display system 1 for connecting an end of a cable 301, and the information processing apparatus 2 is likewise provided with a connector for connecting the other end of the cable 301. When using the image display system 1, one end of the cable 301 is plugged into the connector of the image display system 1, and the other end of the cable 301 is plugged into the connector of the information processing apparatus 2. Thereby, the image display system 1 is connected to the information processing apparatus 2. The cable 301 may consist of a USB (universal serial bus) cable or other forms of cable equipped with the functions of signal transmission and power supply. Thus, the image display system 1 receives a supply of electric power and data signals for image display from the information process apparatus 2 via the cable 301.

When the image display system 1 is to be transported, the cable 301 is disconnected from both the image display system 1 and the information processing apparatus 2 so that the image display system 1, the information processing apparatus 2 and the cable 3 may be individually transported.

The image display system 1 essentially consists of an optical engine unit (first unit) for projecting laser light onto a screen S and a control unit (second unit) for controlling the optical engine unit as will be discussed hereinafter. The first unit and the second unit are both received within a housing 11 of the image display system 1.

When using the image display system 1, the laser light is properly projected onto the screen S by tilting the main body of the image display system 1 or otherwise adjusting the projecting angle of the laser light.

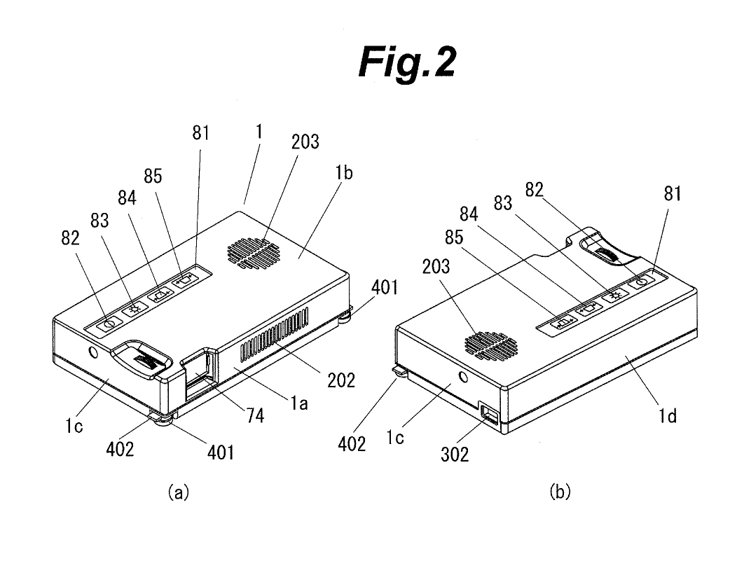

FIGS. 2a and 2b are perspective views of the image display system 1 as seen from two opposite directions. The image display system 1 is provided with a projection window 74 on the front face 1a thereof for conducting laser light generated by the optical engine unit to the outside.

An operation unit 81 is provided on the upper face lb of the image display system 1. The operation unit 81 includes a power switch 82, a brightness switch 83, and a pair of trapezoidal correction switches 84 and 85. By using these switches, the image display system 1 can be turned on and off, and the displayed image can be adjusted. The upper face lb of the image display system 1 is also provided with an air inlet 203 next to the operation unit 81 for admitting air from the outside. Also, an air outlet 202 is provided on the front face la of the image display system 1 next to the projection window 74 to expel the air from inside the image display system 1. The air introduced from the air inlet 203 is expelled from the air outlet 202 after circulating through the optical engine unit.

An electric connector 302 is provided on one side face 1c of the image display system 1 for connecting an end of a cable. By plugging in an end of the cable 301 into this electric connector 302, the image display system 1 and the information processing apparatus 2 are electrically connected to each other.

A pair of tilt adjust members 401 are provided on the lower face of the image display system 1 adjacent to the side of the projection window 74. In this case, the tilt adjust members 401 are provided on the two corners of the image display system 1, respectively, defined by the front edge and the two side edges of the lower face of the image display system 1. If desired, only one tilt adjust member 401, instead of two, may be provided adjacent to a middle point of the front edge of the lower face of the image display system 1.

Each tilt adjust member 401 essentially consists of a vertically extending rod member that can be pulled out from the image display system 1 and fixedly secured at a desired position by using a lock mechanism 402 provided on the adjacent side face 1c (or the front face if only one tilt adjust member 401 is used). Thereby, the tilt angle of the image display system 1 can be adjusted. More specifically, when the tilt adjust members 401 are pulled out by a relatively large length, the front face (where the projection window 74 is located) is significantly more raised than the rear face (which is opposite to the front face), and the tilt angle of the image display system 1 is hence increased. When the tilt adjust members 401 are pulled out by a relatively small length, the front face (where the projection window 74 is located) is only slightly more raised than the rear face (which is opposite to the front face), and the tilt angle of the image display system 1 is hence decreased.

The operation unit 81 and the adjusting arrangements are located on the front face, upper face 1b, side face 1c and lower face, but not on the rear face. Therefore, the rear face 1d is totally devoid of any component or feature, and is configured to be substantially flat.

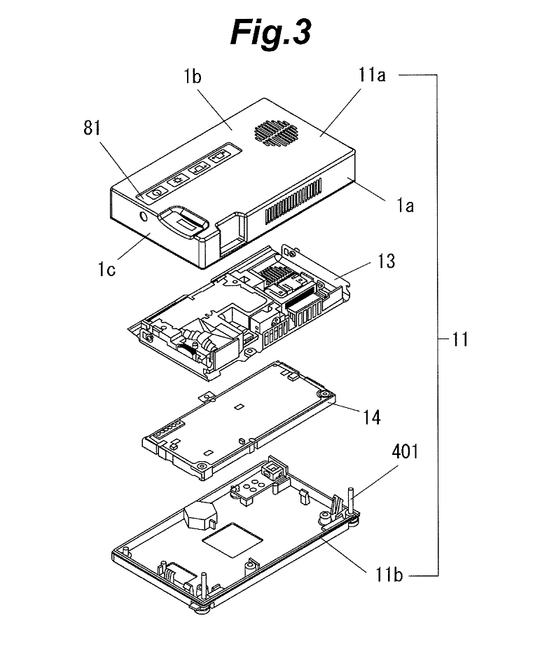

FIG. 3 is an exploded perspective view of the image display system 1. The image display system 1 essentially consists of a housing 11, an optical engine unit 13 (first unit) and a control unit (second unit) 14.

The housing 11 consists of an upper housing 11a (having a relatively large depth) defining the front face 1a, upper face 1b, side face 1c and rear face 1d of the image display system 1, and a lower housing 11b (having a relatively small depth) defining the lower face of the image display system 1. The optical engine unit 13 and the control unit 14 are encased in the housing 11 by bringing together the upper and lower housings 11a and 11b from above and below. The housing 11 is formed by fitting the upper and lower housings 11a and 11b to each other, and is provided with the shape of a rectangular box.

The optical engine unit 13 contains an optical system for projecting an image onto a screen or optical components for projecting laser light onto a screen S. The optical engine unit 13 is located inside the upper housing 11a of the housing 11 or in an upper part of the image display system 1.

The control unit 14 contains a control circuit board for controlling the optical components in the optical engine unit 13, and is electrically connected to the optical engine unit 13. The control unit 14 is located inside the lower housing 11b of the housing 11 or in a lower part of the image display system 1.

As the image display system 1 contains the optical engine unit 13 and the control unit 14 one above the other, the wall area of the housing 11 can be minimized, and the footprint of the image display system 1 can be minimized. The housing of the image display system 1 is box-shaped so that the image display unit 1 can be easily carried by a user. In particular, the image display system 1 is both highly compact in size and simple in shape so as to be highly transportable.

Also, because the optical engine unit 13 and the control unit 14 are received in the housing 11 one above the other, the height of the image display system 1 can be increased without increasing the gap between the two units 13 and 14 and the gap between each unit and the housing 11. As opposed to the case where the optical engine unit 13 and the control unit 14 are arranged laterally one next to the other, the image display system 1 can be made highly compact so that the image display system 1 can even be placed in a pocket of the garment worn by the user.

When using the image display system 1 under a normal condition, the image display system 1 is placed on a surface with the operation unit 81 facing upward. If the image display system 1 is placed on the top surface of a table, and the image is to be projected onto an upper part of a wall of the room, it is necessary to tilt the image display system 1 upward. As the optical engine unit 13 is located above the control unit 14, the optical engine unit 13 is located in a relatively upper part of the image display system 1 so that the desired image can be obtained while minimizing the tilting angle of the image display system. This allows the range of the titling angle adjustment by the tilt adjust members 401 to be decreased so that the tilt adjust members 401 can be constructed as highly compact units.

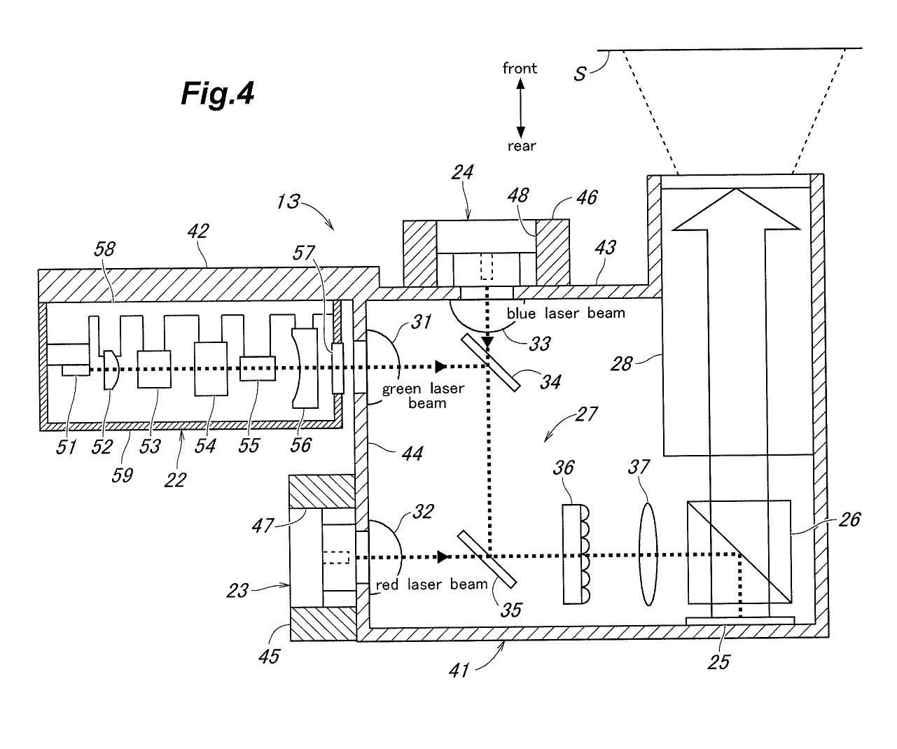

FIG. 4 is a diagram showing the structure of the optical engine unit 13 of the image display system 1. The optical engine unit 13 comprises a green laser light source unit 22 for emitting a green laser beam, a red laser light source unit 23 for emitting a red laser beam, a blue laser light source unit 24 for emitting a blue laser beam, a spatial light modulator 25 of a reflective LCD type for forming the required image by spatially modulating the laser beams from the green, red and blue laser light source units 22 to 24 according to the given video signal, a polarizing beam splitter 26 that reflects the laser beams emitted from the green, red and blue laser light source units 22 to 24 onto the spatial light modulator 25 and transmits the modulated laser beam emitted from the spatial light modulator 25, a relay optical system 27 for directing the laser beams emitted from the green, red and blue laser light source units 22 to 24 to the beam splitter 26, and a projector lens system (projection optical system) 28 for projecting the image created by the modulated laser beam and transmitted through the beam splitter 26 onto the screen S. The laser light source units 22 to 24 use semiconductor lasers as light sources.

The optical engine unit 13 is configured to display a color image on the screen S by using the field sequential process (time sharing display process), and the laser beams of different colors are emitted from the corresponding laser light source units 22 to 24 sequentially in a time sharing manner so that the laser beams of the different colors emitted intermittently and projected onto the screen are perceived as a unified color afterimage.

The relay optical system 27 comprises collimator lenses 31 to 33 for converting the laser beams of different colors emitted from the corresponding laser light source units 22 to 24 into parallel beams of the different colors, first and second dichroic mirrors 34 and 35 for directing laser beams of the different colors exiting the collimator lenses 31 to 33 in a prescribed direction, a diffusion plate 36 for diffusing the laser beams guided by the dichroic mirrors 34 and 35 and a field lens 37 for converting the laser beam transmitted through the diffusion plate 36 into a converging laser beam.

If the side of the projector lens system 28 from which the laser beam is emitted to the screen S is defined as the front side, the blue laser light source unit 24 emits the blue laser beam in the rearward direction. The green and red laser light source units 22 and 23 emit the green laser beam and red laser beam, respectively, in a direction perpendicular to the blue laser beam. The blue, red and green laser beams are conducted to a common light path by the two dichroic mirrors 34 and 35. More specifically, the blue laser beam and green laser beam are conducted to a common light path by the first dichroic mirror 3, and the blue laser beam, red laser beam and green laser beam are conducted to a common light path by the second dichroic mirror 3.

The surface of each dichroic mirror 34, 35 is coated with a film that selectively transmits light of a prescribed wavelength while reflecting light of other wavelengths. The first dichroic mirror 34 transmits the blue laser beam while reflecting the green laser beam, and the second dichroic mirror 35 transmits the red laser beam while reflecting the blue and green laser beams.

These optical components are received in a housing 41 which is made of thermally conductive material such as aluminum and copper so as to serve as a heat sink for dissipating the heat generated from the laser light source units 22 to 24.

The green laser light source unit 22 is mounted on a mounting plate 42 secured to the housing 41 and extending laterally from the housing 41. The mounting plate 42 extends from the corner between a front wall 43 and a side wall 44 of the housing 41 in a direction perpendicular to the side wall 44. The red laser light source unit 23 is retained in a holder 45 which is in turn attached to the outer surface of the side wall 44, and the blue laser light source unit 24 is retained in a holder 46 which is in turn attached to the outer surface of the front wall 43.

The red and blue laser light source units 23 and 24 are each prepared in a CAN package in which a laser chip supported by a stem is placed on the central axial line of a can so as to emit a laser beam in alignment with the central axial line of the can and out of a glass window provided on the can. The red and blue laser light source units 23 and 24 are secured to the respective holders 45 and 46 by being press fitted into mounting holes 47 and 48 formed in the corresponding holders 45 and 46. The heat generated in the laser chips of the red and blue laser light source units 23 and 24 is transmitted to the housing 41 via the holders 45 and 46, and is dissipated to the surrounding environment from the housing 41. The holders 45 and 46 may be made of thermally conductive material such as aluminum and copper.

The green laser light source unit 22 comprises a semiconductor laser 51 for producing an excitation laser beam, a FAC (fast axis collimator) lens 52 and a rod lens 53 for collimating the excitation laser beam produced from the semiconductor lens 51, a laser medium 54 for producing a base wavelength laser beam (infrared laser beam) through excitation by the excitation laser beam, a wavelength converting device 55 for producing a half wavelength laser beam (green laser beam) by converting the wavelength of the base wavelength laser beam, a concave mirror 56 for forming a resonator in cooperation with the laser medium 54, a glass cover 57 for preventing the leakage of the excitation laser beam and base wavelength laser beam, a base 58 for supporting the various component parts and a cover member 59 covering the various components.

The base 58 of the green laser light source unit 22 is fixedly attached to the mounting plate 42 of the housing 41 such that a gap of a prescribed width (such as 0.5 mm or less) is formed between the green laser light source unit 22 and the side wall 44 of the housing 41. Thereby, the heat generated from the green laser light source unit 22 is insulated from the red laser light source unit 23 so that the red laser light source unit 23 having a relatively low tolerable temperature is prevented from heat, and is enabled to operate in a stable manner. To obtain a required adjustment margin (such as about 0.3 mm) for the optical center line of the red laser light source unit 23, a certain gap (such as 0.3 mm or more) is provided between the green laser light source unit 22 and the red laser light source unit 23.

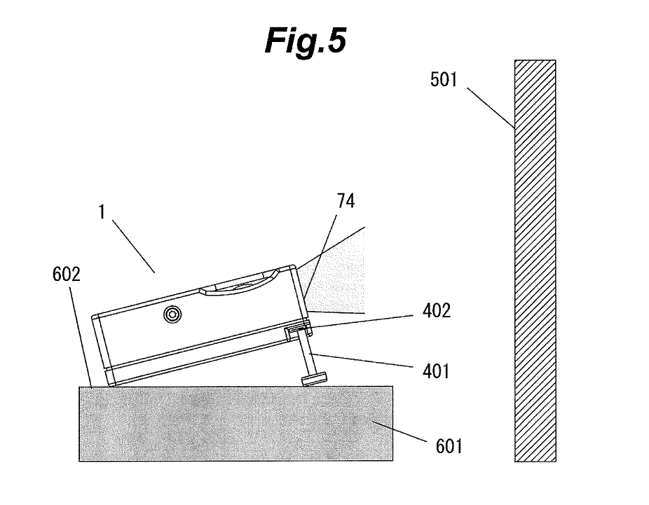

FIG. 5 is a side view showing the image display system projecting an image onto a wall in an upwardly slanted direction. The image display system 1 is placed on the top surface 602 of a table 601.

Each tilt adjust member 401 is pulled outward from the lower face of the image display system 1, and is held at a desired position by using the lock mechanism 402. The image display system 1 is placed on the horizontal top surface 602 of the table 601. Thereby, the image display system 1 can be held at a desired tilt angle so that the light projected from the projection window 74 can be directed toward the wall surface 501 serving as a screen in an upwardly slanted direction.

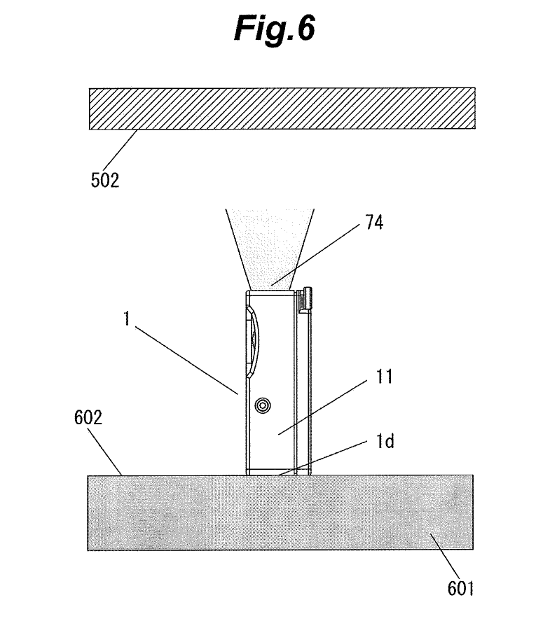

FIG. 6 is a side view showing the image display system 1 projecting an image onto a ceiling surface 502 in a vertical direction. The image display system 1 is placed on the top surface 602 of a table 601.

The image projecting system 1 is placed on the horizontal top surface 602 of the table 601 so as to sit on the rear face 1d thereof. Therefore, the projection window 74 is directed upward so that an image can be projected on a ceiling surface 502. As the rear face 1d is generally flat, and is provided with no operation unit or an adjustment unit, the image display system 1 can sit on the rear face 1d thereof so as to direct the projection window 74 upward in a highly stable manner. The rear face 1d is required to be flat only to the extent that the image projecting system 1 can stand on the rear face 1d in a stable manner, and may be provided with depressions and projections as long as the image projecting system 1 can stand on the rear face 1d in a stable manner.

As the housing of the image display system 1 is shaped as a rectangular box, the projection window 74 can be directed upward in an accurate manner. As the optical engine unit 13 and the control unit 14 are received within the housing 11 one on top of the other, the area of the rear face Id of the image display system 1 can be made relatively large, and this improves the stability of the image display system 1 when standing on the rear face 1d thereof.

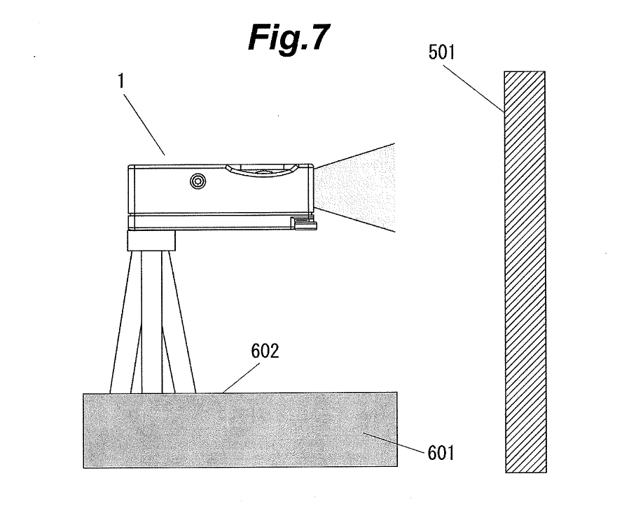

FIG. 7 is a side view showing the image display system 1 projecting an image onto a wall surface in a horizontal direction. The image display system 1 is placed on the top surface 602 of a table 601.

The bottom face of the image display system 1 is provided with a threaded hole for mounting the image display system 1 on top of a tripod. By mounting the image display system 1 on a tripod, and placing the tripod on the table 601, the image display system 1 can be spaced away from the horizontal top surface 602 of the table 601. Therefore, the image display system 1 in this configuration can project light emitted from the projection window 74 onto a vertical wall surface 501 substantially in a horizontal or lateral direction at a suitable height.

As the optical engine unit 13 and the control unit 14 are received within the housing 11 one on top of the other, the area of the wall of the housing 11 defining the external contour of the image display system 1 can be minimized. As the housing 11 of the image display system 1 is shaped as a rectangular box, the image display system 1 can be easily carried by the user. In short, the image display system of the present invention is compact in size and simple in shape so as to be easily handled and transported by the user. For instance, the user may put the image display system in his chest pocket.

Although the present invention has been described in terms of a preferred embodiment thereof, it is obvious to a person skilled in the art that various alterations and modifications are possible without departing from the scope of the present invention which is set forth in the appended claims.

The contents of the original Japanese patent applications on which the Paris Convention priority claim is made for the present application as well as the contents of the prior art references mentioned in this application are incorporated in this application by reference.

1. An image display system, comprising:
a first unit containing an optical system for projecting an image on a screen;
a second unit containing a control circuit board for controlling the optical system and electrically connected to the first unit; and
a housing containing the first unit and the second unit one above the other therein, and having a rectangular box shape.

2. The image display system according to claim 1, wherein the first unit is located above the second unit.

3. The image display system according to claim 1, wherein the housing comprises a projection window for emitting light generated by the first unit to outside, and a face of the housing facing away from the projection window is shaped planar such that the projection window faces upward when the planar face is placed on a horizontal surface.
